(19) United States
(12) Patent Application Publication
(10) Pub. No.: US 2026/0070262 A1
(43) Pub. Date: Mar. 12, 2026

(54) Intelligent Drum Cycles for Concrete Mixers

(71) Applicant: Total Vehicle Solutions Group Limited, Wisbech (GB)

(72) Inventors: Darren Davies, Buckingham (GB); Kevin Walker, Wisbech (GB); Matthew Hicks, Buckingham (GB); Vito Ronzano, JR., Wisbech (GB)

(21) Appl. No.: 19/106,624

(22) PCT Filed: Aug. 25, 2023
(86) PCT No.: PCT/GB2023/052207

§ 371 Date: Feb. 25, 2025

(30) Foreign Application Priority Data
Aug. 26, 2022 (GB) 2212432.5

(51) Int. Cl. B28C 5/42

(52) U.S. Cl. CPC B28C 5/4248; B28C 5/422

(57) ABSTRACT

This specification relates to systems, methods and apparatus for automating and guiding the delivery of concrete from a concrete mixer. According to a first aspect of this specification, there is described a system for positioning a delivery chute (104, 210) of a concrete mixer vehicle (100, 200), the system comprising: one or more vehicle positioning sensors (116) for determining location data specifying a location of the concrete mixer vehicle (100, 200); the delivery chute (104, 210) for delivering the concrete mix from a concrete mixing drum (102) to a target location (204), the delivery chute (104, 210) comprising: one or more chute positioning sensors (112) for monitoring a position of the delivery chute (104, 210); and one or more actuators (110) for positioning the delivery chute (104, 210); one or more processors; and a memory, the memory storing computer readable instructions that, when executed by the one or more processors, cause the system to perform a method positioning a delivery chute (104, 210) of a concrete mixer vehicle (100, 200). The method comprises: determining, based on the location data, whether the concrete mixer vehicle (200) is at a target vehicle location (206); initiating, based at least in part on determining that the concrete mixer vehicle (200) is at the target vehicle location (206), deployment of the delivery chute (210) from the concrete mixing vehicle (200); positioning, based at least in part on data from the one or more chute positioning sensors (112), the delivery chute (210) to a target delivery location (204) using the one or more actuators (110); and indicating, to a user of the concrete mixer vehicle, that the chute is in a correct position for concrete delivery.

### FIELD

This specification relates to systems, methods and apparatus for automating and guiding the delivery of concrete from a concrete mixer.

### BACKGROUND

Currently, vehicle arrives at delivery site, the vehicle is positioned near discharge area by the operator/driver, who then exits vehicle to assemble a delivery chute, e.g. by adding chute extensions to main chute as required to reach desired length. The chute is then manually manipulated to reach discharge area. As discharge commences, operator may also manually traverse the chute to spread concrete. After discharge, the operator typically washes down chutes in cleaning areas, or into a vehicle washbox, and then dismantles and restows the chute assembly.

This process has multiple time/efficiency/financial costs and also health and safety implications as the operator must leave the vehicle and operate on a site with new and possibly complex health and safety requirements.

### SUMMARY

According to a first aspect of this specification, there is described a system for positioning a delivery chute of a concrete mixer vehicle, the system comprising: one or more vehicle positioning sensors for determining location data specifying a location of the concrete mixer vehicle; the delivery chute for delivering the concrete mix from a concrete mixing drum to a target location, the delivery chute comprising: one or more chute positioning sensors for monitoring a position of the delivery chute; and one or more actuators for positioning the delivery chute; one or more processors; and a memory, the memory storing computer readable instructions that, when executed by the one or more processors, cause the system to perform a method positioning a delivery chute of a concrete mixer vehicle. The method comprises: determining, based on the location data, whether the concrete mixer vehicle is at a target vehicle location; initiating, based at least in part on determining that the concrete mixer vehicle is at the target vehicle location, deployment of the delivery chute from the concrete mixing vehicle; positioning, based at least in part on data from the one or more chute positioning sensors, the delivery chute to a target delivery location using the one or more actuators; and indicating, to a user of the concrete mixer vehicle, that the chute is in a correct position for concrete delivery.

According to a second aspect of this specification, there is described a concrete mixer vehicle comprising: a concrete mixing drum; and a system according to the first aspect.

According to a third aspect of this specification, there is described a method for positioning a delivery chute of a concrete mixer vehicle comprising: determining, based on location data captured from one or more vehicle positioning sensors of a concrete mixer vehicle, whether the concrete mixer vehicle is at a target vehicle location; initiating, based at least in part on determining that the concrete mixer vehicle is at the target vehicle location, deployment of a delivery chute from the concrete mixing vehicle; positioning, based at least in part on data from one or more chute positioning sensors of the delivery chute, the delivery chute to a target delivery location using the one or more actuators; and indicating, to a user of the concrete mixer vehicle, that the chute is in a correct position for concrete delivery.

According to a fourth aspect of this specification, there is described a computer program product comprising computer readable instructions that, when executed by a system according to the fist aspect, cause the system to perform a method according to the second aspect.

Aspects of this specification may optionally include one or more of the following features, either alone or in combination.

The method may further comprise determining the target vehicle position based on based on the target delivery location and a set of positions reachable by the delivery chute from the concrete mixer vehicle. The target vehicle position may comprise a range of locations from which the target delivery location is reachable by the delivery chute when the concrete mixer vehicle is positioned there.

The one or more vehicle positioning sensors may comprise an optical sensor. Determining whether the concrete mixer vehicle is at the target vehicle location may comprise detecting an optical marker using the optical sensor.

The one or more vehicle positioning sensors may comprises a satellite positioning sensor, such as GPS. Determining whether the concrete mixer vehicle is at the target vehicle location may comprise detecting that the vehicle is in a predefined location or range of locations using the satellite positioning sensor.

The one or more vehicle positioning sensors may comprise a laser target detection sensor. Determining whether the concrete mixer vehicle is at the target vehicle location may comprise detecting a laser marker positioned at the target delivery location.

The system may further comprise a display. The method may further comprise: determining, based at least in part on data from the one or more chute positioning sensors and/or the one or more vehicle positioning sensors a position of the concrete mixer vehicle relative to the target delivery location; and causing the position of the concrete mixer vehicle relative to the delivery location to be displayed on the display. The method may further comprise indicating a range of the delivery chute on the display when displaying the position of the concrete mixer vehicle relative to the target delivery location.

Positioning the delivery chute to the target delivery location using the one or more actuators may comprise automatically positioning the delivery chute at a pre-defined height above the target delivery location. Positioning the delivery chute to the target delivery location using the one or more actuators may comprise: determining, based on data from the one or more chute positioning sensors, presence of an object in the delivery chute path to the target delivery location; and in response to determining the presence of an object in the delivery chute path to the target delivery location, adjusting the delivery chute path to avoid the detected object or halting motion of the delivery chute until the object is no longer detected.

The method may further comprise, subsequent to indicating that the chute is in a correct position for concrete delivery, delivering the concrete mix from the concrete mixing vehicle to the target delivery location. Delivering the concrete mix from the concrete mixing vehicle to the delivery location may comprise: determining a slump of the concrete mix; and setting, based on a target delivery rate and the slump of the concrete mix, a concrete drum rotation speed for delivery of the concrete mix. Delivering the concrete mix from the concrete mixing vehicle to the delivery location may comprise applying, using the one or more actuators, vertical and/or horizontal oscillations to the delivery chute during delivery of the concrete mix.

The delivery chute may further comprises one or more water outlets. The method may further comprise, subsequent to delivering the concrete mix from the concrete mixing vehicle to the delivery location: positioning, based at least in part on data from the one or more chute positioning sensors, the delivery chute in a wash-down position; and expelling, from the one or more water outlets, water into the delivery chute.

The one or more actuators for positioning the delivery chute may comprise one or more of: an electric motor; a hydraulic motor; and/or lead screws.

The one or more chute positioning sensors may comprise any one or more of: one or more optical sensors; one or more LIDAR sensors; one or more acoustic sensors; one or more displacement sensors; and/or motor encoders.

### BRIEF DESCRIPTION OF THE DRAWINGS

Example implementations will be described by way of reference to the accompanying drawings, in which:

FIG. 1 shows a schematic diagram of a concrete mixer vehicle comprising a system for positioning a delivery chute;

FIGS. 2A-D show a schematic overview of an example method for positioning a delivery chute of a concrete mixer vehicle;

FIG. 3 shows an example of a visual aid for positioning a delivery chute of a concrete mixer vehicle;

FIG. 4 shows a flow diagram of an example method for positioning a delivery chute of a concrete mixer vehicle at a target delivery location; and

FIG. 5 shows a schematic overview of a computer system for use in performing any of the methods described herein

### DETAILED DESCRIPTION

This specification describes an automated, or partially automated, system for positioning the delivery chute of a concrete mixer vehicle.

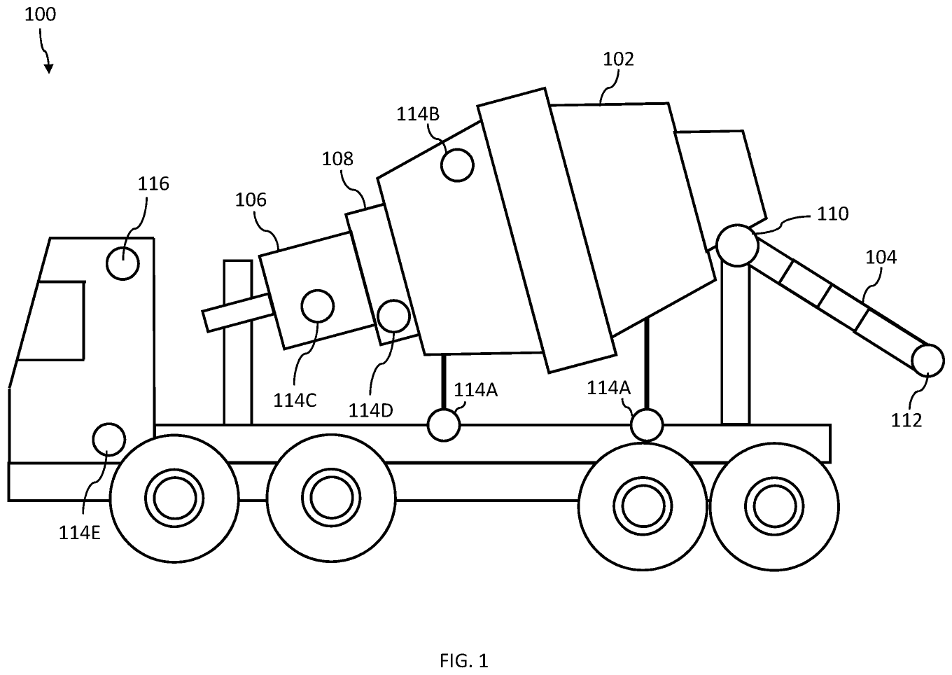

FIG. 1 shows a schematic diagram of a concrete mixer vehicle 100 comprising a concrete mixing drum 102 and a system for positioning a delivery chute 104.

The vehicle 100 comprises a drum 102 for mixing a concrete mix (also referred to herein as a “payload”). The drum 102 is rotatable about a central axis to mix the concrete. The drum 102 may contain internal protrusions (not shown) to aid turning of the concrete mix. The protrusions may be configured to push the concrete mix either forward to backwards in the drum 102, depending on the rotation direction of the drum 102. A drive motor 106 is coupled to drum via a gearbox 108. The drive motor 106 applies torque to the drum 104 via the gearbox 108 in order to rotate the drum 104. The drive motor 106 may be a bi-directional drive motor, i.e. capable of rotating the drum 104 both clockwise and anti-clockwise around the central axis. The drive motor 106 may be a hydraulic or electric motor.

The vehicle 100 further comprises a delivery chute 104 for delivering a concrete mix from the mixing drum 102 of the vehicle 100 to a target location. The delivery chute 104 comprises one or more actuators 110 for positioning the delivery chute and one or more chute positioning sensors 112 for monitoring a position of the delivery chute. The delivery chute 104 may be an articulated and/or telescoping chute. Note that the location and orientation of the delivery chute 104 and its components is illustrative, and they may be positioned and/or oriented differently.

A concrete mix may be delivered from the drum 102 to a target location via the delivery chute 104. For example, the drum 102 may rotate such that the concrete mix is pushed by its internal protrusions towards a discharge hole of the drum (i.e. an open end) that is fluidly connected to an entrance of the delivery chute 104. This rotation of the drum 102 pushes concrete mix into the entrance of the delivery chute 104, from which it slides down the chute 104 to the exit of the chute. The concrete mix is delivered via the exit of the chute 104 to a target delivery location. In some embodiments, the one or more actuators 110 make shake the delivery chute 104 during discharge of the concrete mix, e.g. apply vertical and/or horizontal oscillations to the delivery chute 104.

The one or more actuators 110 for positioning the delivery chute may comprise an electric motor, a hydraulic motor and/or lead screws. This can allow the delivery chute 104 to be configured as required, for example making it longer by extending the chute 104 and/or raising the chute to 104 increase the height of the exit point of the concrete mix.

The one or more chute positioning sensors 112 may comprise one or more displacement sensors (e.g. rotary or linear displacement sensors) and/or motor encoders. These allow the position and/or speed of the delivery chute relative to the vehicle 100 to be determined during positioning of the delivery chute 104.

The one or more chute positioning sensors 112 may alternatively or additionally comprise one or more switches for detecting known/predetermined positions/extensions of the delivery chute 104. The predetermined positions may, for example, corresponding to one or more of: a home position; an un-extended position; one or more fractionally extended positions (e.g. half extended, one quarter extended, three quarters extended etc.); and/or a fully extended position.

The one or more chute positioning sensors 112 may alternatively or additionally comprise one or more proximity sensors for detecting obstacles in the path of the deliver chute 104. Examples of such sensors include, but are not limited to: ultrasonic sensors or other types of acoustic sensor; and/or LIDAR sensors.

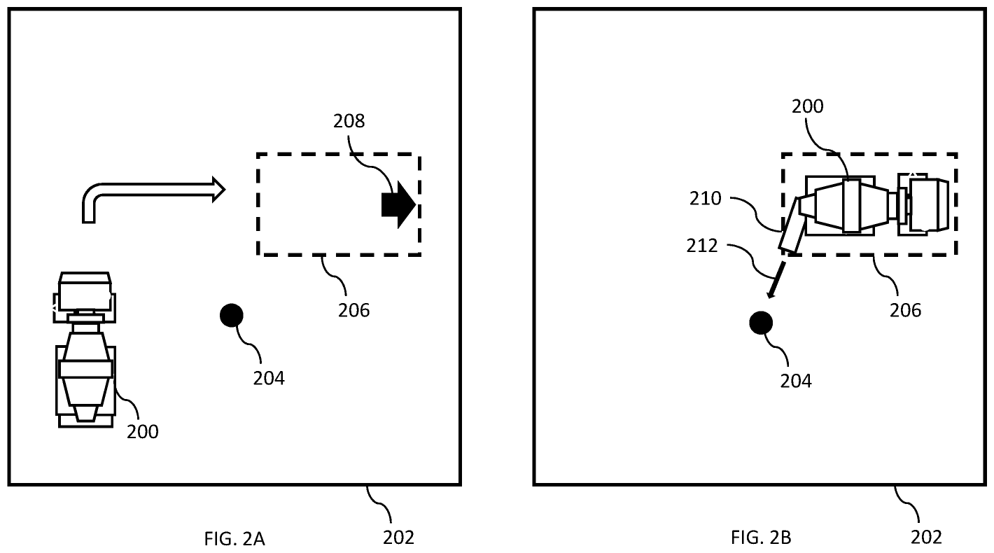

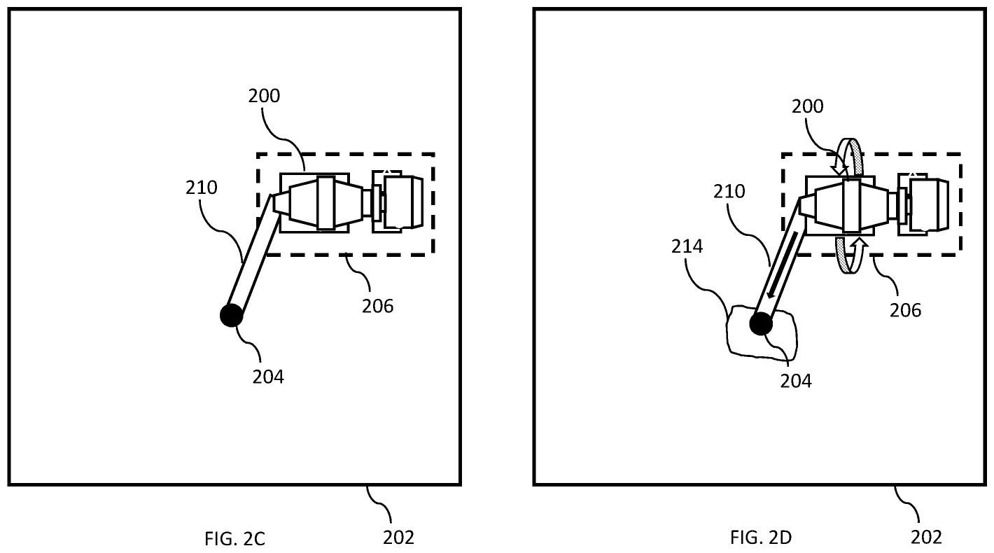

The one or more chute positioning sensors 112 may alternatively or additionally comprise one or more targeting sensors for detecting the location of a target delivery point. The one or more targeting sensors may, for example, comprise LIDAR sensors. The one or more targeting sensors may, for example, comprise an optical sensor, such as a camera or laser target detection system. Methods of detecting the target delivery location using the one or more positioning sensors 112 are described in more detail below with respect to FIG. 2.

The vehicle 100 further comprises one or more vehicle positioning sensors 116 for determining location data specifying a location of the vehicle 100. The one or more vehicle positioning sensors 116 may comprise, for example a satellite positioning system, such as a GPS system. Alternatively or additionally, the one or more vehicle positioning sensors 116 may comprise one or more optical/LIDAR sensors for determining a relative position of the vehicle 100 with respect to a target vehicle position based on visual data. The target vehicle position may be defined, for example, using an optical marker, such as a QR code or laser pointer positioned at or near the target delivery location. The one or more vehicle positioning sensors 116 may be further be configured to determine an orientation of the concrete mixing vehicle.

The vehicle 100 may further comprise a plurality of sensors 114. The sensors 114 are configured to measure properties of the vehicle 104, and/or the concrete mix in the concrete mixing drum 104. The sensors 114 may supply the sensor data to an electronic control unit (ECU, not shown), which can process then to determine derived measurements of properties of the system.

The plurality of sensors may comprise one or more load sensors 114A. The load sensors 114A are configured to measure the load of the concrete mixer, e.g. the mass of the drum 102 plus the mass of the concrete mix in the drum 102. In some embodiments, the one or more load sensors comprises at least two load sensors 114A: a front load sensor arranged to measure the load at the front of the drum 102 (i.e. the end closest to the drum 102 mouth); and a rear load sensor arranged to measure the load at the rear of the drum 102 (i.e. the end furthest from the drum 102 mouth). The load sensors 114A may be zeroed prior to the concrete mix being loaded to account for build-up of dried concrete in the drum

The plurality of sensors may further comprise a drum temperature sensor 114B configured to measure the temperature of the drum or the concrete in the drum directly. The temperature can be a contact temperature (either internal or external to the drum) or a non-contact temperature measurement. The temperature of the concrete mix can be an important factor in determining the slump of the concrete, since the temperature affects the evaporation rate of moisture in the concrete mix.

The plurality of sensors may further comprise one or more (e.g. a plurality) of motor state sensors 114C configured to measure the state of the motor 106 driving the drum 102, e.g. the current/voltage supplied to the motor for an electric motor, the input and output hydraulic pressures for a hydraulic motor, the motor temperature, the hydraulic fluid temperature and/or the motor rotation speed. The motor state sensors 114C may further comprise a drum speed sensor, such as an optical encoder or magnetic sensor, though this may alternatively be fitted to the drum itself, when present.

The plurality of sensors 114 may further comprise one or more (e.g. a plurality) of gearbox state sensors 114D configured to measure the state of the drum gearbox 108, e.g. the input torque/rotation speed to the gearbox, the gearbox temperature, the gearbox fluid level, or the like. Each of the gearbox state sensors 110E may be fitted to the gearbox directly, or to some other part of the system, e.g. the motor for an input torque sensor.

The plurality of sensors 114 may further comprise one or more speed sensors 114E configured to determine the speed of the vehicle 100.

It will be appreciated that there are multiple possible sensors or combinations of sensors that can be arranged to measure the variables required for the methods used herein. Multiple possible sensors or combinations of sensors that can be arranged to measure the variables required for the methods used herein. As an example, the input torque may be determined using a direct torque measurement via torque sensor on the drive system. Alternatively, the torque can be derived indirectly from other measurements of the motor, such as input current, input and output hydraulic pressures or the like. As another example, the drum speed may be determined from the motor speed and the gearbox ratio, or alternatively measured directly.

The sensors may be connected to an electronic control unit (ECU, not shown) of the concrete mixer. The ECU may use the sensor data to determine properties of the concrete drum 102, vehicle 100 and/or concrete mix, and to control these and/or other elements of the system, as described below.

FIGS. 2A-D show a schematic overview of an example method for positioning a delivery chute of a concrete mixer vehicle. The method may be performed with the aid of a vehicle positioning system and chute positioning system of the concrete mixer vehicle.

In FIG. 2A, the concrete delivery vehicle 200 has entered a delivery environment 202 (e.g. a building site). Within the environment is a target delivery location 204 to which a concrete mix in the mixing drum of the vehicle 200 should be delivered. One or more target vehicle locations 206 at which the vehicle 200 should be positioned to deliver the concrete may also be defined.

The target delivery location 204 may be defined using one or more optical markers (not shown) in the delivery environment 202. The optical markers may comprise a pattern recognisable by optical sensors on the concrete mixing vehicle. For example, an optical marker, such as a QR code, may be placed at the delivery location. Alternatively, one or more optical markers may be placed at locations around the delivery environment, and the target delivery location 204 defined relative to these markers.

Alternatively, the target delivery location 204 may be defined by a set of coordinates, or range of coordinates, in a satellite positioning system. For example, the target location may be defined as a location in a GPS system.

Alternatively, the target delivery location 204 may be defined using a handheld laser pointer operated by an on-site user. The laser marker may be detectable by one or more laser detection sensors on the concrete mixing vehicle.

The target vehicle location 206 may be defined based on a set of positions/locations from which the delivery chute of the concrete mixing vehicle 200 can reach the target delivery location 204. For example, one or more concrete mixer vehicle 200 positions/locations from this set of positions may be defined as the target vehicle location 206. The target vehicle location 206 may comprise a single vehicle position, for example an optimal position for the concrete vehicle 200. Alternatively, the target vehicle location 206 may comprise one or more ranges of positions/locations.

In some embodiments, the target vehicle position may further comprise one or more target orientations 208 of the concrete mixer vehicle. The target orientation 208 may be position dependent; it may take different values in different target vehicle positions 206 to ensure that the delivery chute can reach the target delivery location.

The set of positions forming the target vehicle location 206 and, in some embodiments, the one or more target orientations 208 may be defined automatically by the positioning system of the concrete mixer vehicle 200 based on the target delivery location and the reachable range of the delivery chute from the concrete mixer vehicle 200. Such embodiments allow flexibility in the type of concrete mixer vehicle 200 used for deliveries.

Alternatively, the target vehicle location 206 and, in some embodiments, the one or more target orientations 208 may be defined may be defined manually by an operator of the concrete delivery vehicle and/or on-site user. Such embodiments allow on-site conditions to be accounted for when defining the target vehicle location 206. In either case, a current vehicle location (and, in some embodiments, orientation) is repeatedly compared to the target vehicle location 206 (and, in some embodiments, target orientation 208) during manoeuvring of the concrete mixer vehicle 200. If the concrete mixer vehicle 200 is in the target vehicle location 206 (and, in some embodiments, target orientation 208), then an indication is output to the operator of the concrete mixer vehicle 200. For example, an optical and/or audio indication may be output to the operator.

Alternatively, in some embodiments, the target vehicle location 206 is determined on-the-fly while positioning the concrete mixer vehicle. Instead of having a predefined target vehicle location 206, the positioning system of the concrete mixer vehicle 200 compares a current set of locations reachable by the delivery chute of the concrete mixer vehicle 200 to the target delivery location 204. If the target delivery location 204 falls within the current set of locations reachable by the delivery chute then an indication is provided to the operator that the concrete mixer vehicle 200 is in a valid target vehicle position 206. For example, an optical and/or audio indication may be output to the operator.

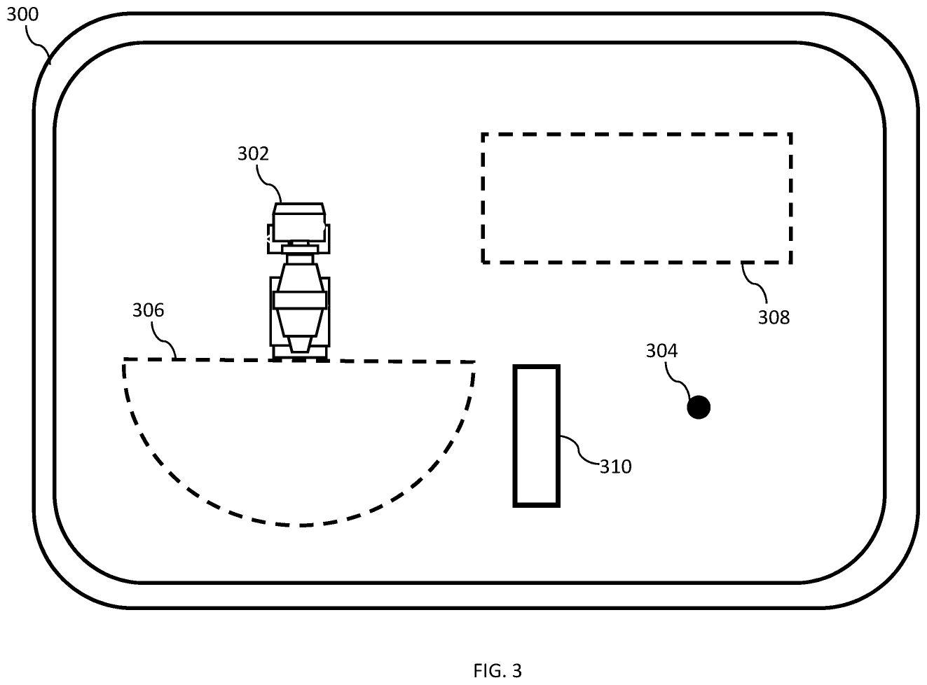

In some embodiments, an in-cab display may be used to guide the operator when positioning the concrete mixer vehicle 200, as described in more detail below with respect to FIG. 3.

In FIG. 2B, the operator has positioned the concrete mixer vehicle 200 at the target location 206, and initiated deployment of the delivery chute 210.

Once the vehicle positioning system has determined that the concrete mixer vehicle 200 is at a target location, deployment of the delivery chute 210 from a stowed position on the concrete mixer vehicle 200 may be activated. For example, the operator may manually initiate chute deployment from the cab of the concrete mixer vehicle 200.

Once deployment of the delivery chute 210 is initiated, the exit of the delivery chute 210 is guided to delivery location based on sensor data from one or more chute positioning sensors of the concrete vehicle 200. Actuators of the delivery chute are used to position the delivery chute 210 at the delivery location 204, for example by extending the length delivery chute 210, raising and/or lowering the height of the delivery chute above the ground, and/or varying angles of the delivery chute 210 with respect to the concrete mixer vehicle. The deployment of the delivery chute 210 may be fully automated, partially automated or fully manual.

In embodiments with fully automated deployment, a chute positioning system detects the target delivery location 204, for example by determining an offset between the current position of the vehicle 200 and the target delivery location 204, and automatically deploys the chute to the target position with a predetermined offset height, e.g. 100 mm above the target delivery position 204. The lateral/longitudinal position of the delivery chute 210 can be modified to account for the height of the chute 210 above the target delivery position 204 and, in some embodiments, allow for the concrete to fall quickly or slowly depending on a target delivery rate and slump of the concrete mix. For example, a low rate of slump delivery at height close to target height will fall quickly so minimal position modification is required.

During deployment, one or more positioning sensors of the delivery chute 210 may be used to detect obstacles in the path 212 of the deliver chute 210. If an obstacle is detected, the positioning of the delivery chute may be paused until the obstacle is removed/moves. Alternatively or additionally, the delivery chute 210 may be repositioned (e.g. raised or lowered) to avoid the obstacle. For example, proximity sensors on the chute 210 may be used to avoid any collisions by pausing deployment if obstacles are detected.

Deployment of the delivery chute 210 may also be programmed to avoid contact with itself or the vehicle 200.

In some embodiments, the system can be switched to manual mode for further adjustments during deployment of the delivery chute 210 and/or when the automated system indicates that the chute 210 is in the target delivery location 204 to allow for fine tuning of the delivery chute 210 position.

When chute deployment is activated in a manual mode, an operator (e.g. the operator in the cab, an on-site user using a remote control, or remote operator) will be able to deploy and/or reposition the chute manually using a controller (e.g. using joystick, joypad or similar controller) to reach the desired delivery location and height above ground, using the chute positioning sensors to guide deployment. In some embodiments, optical sensors in the set of chute positioning sensors may provide real-time image data to the operator to guide deployment. Proximity sensors on the delivery chute 210 may be used to avoid any collisions, for example pausing deployment of the delivery chute 210 if obstacles are detected in the delivery path.

In FIG. 2C, the delivery chute 208 has been positioned at the delivery location 204.

When positioned, whether manually or automatically, an indication may be provided to the operator that the delivery chute 210 is at the target delivery location 204. In some embodiments, the operator (or other on-site user) can confirm that the chute 210 is ready to deliver concrete and this may be shown by indicator lights or other method to show ready to deliver concrete. The operator may then manually initiate delivery of the concrete mix to the delivery location 204 via the delivery chute 210.

Prior to initiating concrete delivery, one or more delivery setting may be provided. These may be provided manually by the operator, or predefined by the client. The one or more delivery settings may comprise one or more of: a delivery amount (i.e. the amount of concrete mix to be provided), e.g. a volume or mass of concrete mix; a delivery rate, e.g. a mass or volume of concrete mix to be delivered per unit time (e.g. per second, per minute). Alternatively, the delivery settings may comprise a target concrete drum speed and rotation time. Alternatively, the delivery settings may comprise a target concrete drum speed only.

If a target delivery rate is provided, the system may use this information along with a current slump value of the concrete mix to determine an optimal drum speed, else it will achieve target drum speed. If a target delivery amount is selected, the system will use a load cell output to deliver predetermined load of concrete before shutting off.

In FIG. 2D, the concrete mix 214 is delivered to the delivery location 204.

Once delivery has been initiated, the concrete mixing drum rotates in the delivery direction at a rate determined based on the delivery settings. The concrete mix is forced towards an opening of the concrete mixing drum by the rotation of the drum and into an opening of the delivery chute 210. The concrete mix slides down the delivery chute 210, and exits the delivery chute 210 at the delivery location. Delivery of the concrete mix continues until a threshold condition is satisfied.

The threshold condition may comprise one or more of: a threshold number of drum rotations; a threshold drum rotation time; a threshold mass of concrete delivered (as determined by the load cells); and/or a threshold volume of concrete mix delivered.

In some embodiments, continuation of the delivery of the concrete mix is based on a system ready signal being present. If the signal is removed, then the delivery may be halted/paused. The signal may be removed manually, or may triggered automatically based on one or more fault conditions. The one or more fault conditions may, for example, comprise: a fault being detected in the delivery process; and/or an obstacle being detected in the delivery area (i.e. at or near the target delivery location). Delivery may recommence when the signal is reset manually.

During delivery of the concrete mix 214, lateral and/or horizontal oscillations may be applied to the delivery chute 210 in order to spread the concrete mix 214 at the target location 204. The oscillations may be performed with a predetermined frequency and/or amplitude, depending on the required delivery conditions.

In some embodiments, the concrete mixer vehicle can operate in a wheel barrow mode, in which a pre-set load of concrete is output from the concrete mixer before shutting off, followed by another issue of the pre-set load. This is repeated until the mode is cancelled.

Following delivery of the concrete mix 214, the delivery chute 210 may undergo a wash down procedure. This may occur automatically, or be selected manually. In the washing mode, the delivery chute 214 is repositioned to a wash-down position. For example, the delivery chute 210 may be repositioned from the target delivery location to a position above a wash box. This repositioning may occur in a similar manner to how the delivery chute was positioned at the target delivery location, e.g., checking proximity sensors for any obstacles. Once in the wash-down position, pressurized water may be provided via water outlets arranged to direct water into the chute 210. The pressurised water may be supplied for a predetermined amount of time, or until halted by operator. During application of the pressurised water, the chute 210 maybe be automatically “rocked” to free off concrete residue using the actuators of the delivery chute 210.

Once delivery and, optionally, the wash down procedure are complete, the delivery chute 210 may be parked to its original location. When parked mode is selected, the chute 210 will deploy to parked position, checking proximity sensors for any obstacles while doing so. If no-wash has occurred, operator may optionally be asked to confirm no-wash required before parking chutes. Once parked, the system will give signal to vehicle and/or drum operating system to indicate that the concrete delivery vehicle is now safe to move off.

FIG. 3 shows an example of a vehicle positioning aid for positioning a delivery chute of a concrete mixer vehicle. The vehicle positioning aid may be displayed to an operator of the concrete mixing vehicle via a display 300 in the cab of the concrete mixing vehicle. The display may be a detachable display mounted in the cab, or form part of integrated display in the cab.

The vehicle positioning aid displays a position of the concrete missing vehicle 302 relative to a target delivery location 304. The relative position may be determine based on location data captured by the vehicle location sensors, as described above. For example, an optical sensor (such as a camera) or LIDAR sensor may be used to determine the relative location of the concrete mixing vehicle 302 to the target delivery location 304. The vehicle positioning aid may be updated in real time based on the location sensor data in order to assist in guiding the operator to a correct position to deliver concrete mix to the target location.

The target delivery location 304 may be detected automatically based on markers present in the delivery environment, as described above. Alternatively, the target delivery location 304 may be at predefined coordinates of a satellite positioning system. In some embodiments, a target delivery location may be defined and/or repositioned manually via a user interface of the display (e.g. a touch screen and/or control panel).

In some embodiments, a chute extension range 306 is also displayed on the vehicle positioning aid. The chute extension range 306 illustrates the maximum range that the concrete delivery chute of the concrete mixer vehicle can be deployed to. The chute extension range 306 defines an area (in the illustrated example, an area behind the concrete mixer vehicle) to which the chute can deliver concrete from the current location of the concrete mixer vehicle.

In some embodiments, a target vehicle location 308 may also be displayed on the vehicle positioning aid. The target vehicle location 308 defines an area in which the concrete mixing vehicle should be positioned in order to reach the target delivery location 304, e.g. so that the target delivery location 304 lies within the chute extension range 306. The target vehicle location 308 may, in some embodiments, also display a target orientation (not shown) for the concrete delivery vehicle at the target vehicle location 308.

In embodiments using optical and/or LIDAR sensors for positioning, positions of obstacles 310 detected in the delivery environment may also be displayed by the vehicle positioning aid to assist the operator.

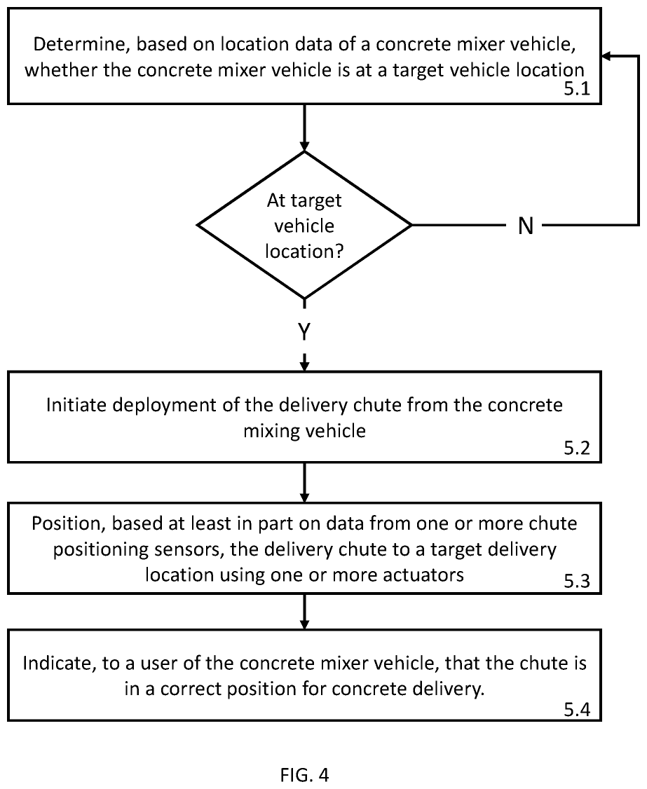

FIG. 4 shows a flow diagram of an example method for positioning a delivery chute of a concrete mixer vehicle at a target delivery location. The method may be performed by the vehicle of FIG. 1, or by a subsystem of said vehicle.

At operation 4.1, location data is used to determine whether the concrete mixing vehicle is at a target vehicle location. The location data originates from vehicle positioning sensors of the concrete delivery vehicle.

In some embodiments, the vehicle positioning sensors comprises one or more optical sensors. The optical sensors are configured to detect one or more optical markers positioned at and/or visible from the target location. Based on detection of the optical markers, a relative position of the vehicle from the optical markers may be estimated using any method known in the art, and compared to a predefined location or range of locations that define the target vehicle location. The optical markers may, for example comprise one or more QR codes located around the delivery location/site.

In some embodiments, the vehicle positioning sensors alternatively or additionally comprises one or more satellite positioning sensors, such as a GPS sensor. Determining whether the concrete mixer vehicle is at the target vehicle location comprises detecting that the vehicle is in a predefined location or range of locations using the satellite positioning sensor, for example by comparing the vehicle location to the predefined location or range of locations of the target vehicle position.

In some embodiments, the vehicle positioning sensors alternatively or additionally comprises one or more laser target detection sensors, configured to detect a laser marker positioned at or near the target delivery location. The laser marker may, for example, be from a hand-held laser pointer wielded by an on-site user used to indicate the target delivery location.

In some embodiments, the one or more target vehicle locations may be a single pre-defined location from which it is known that the concrete delivery chute of the concrete mixer vehicle can reach the target delivery location. Alternatively, the target vehicle locations may be a range of locations from which the delivery chute can reach the delivery location. The target vehicle location may be predefined by a customer, or defined automatically based on the position of the target delivery location. For example, the delivery location may be chosen and, based on the delivery location and properties of the delivery vehicle (e.g. delivery chute range, vehicle size and/or weight etc.) a target location is determined.

In some embodiments, the target vehicle location is determined on-the-fly by determining if the target delivery location is reachable by the delivery chute from the current position of the concrete mixer vehicle. For example, the range of locations that the delivery chute can deliver concrete mix to is compared to the target delivery location. If the target delivery location is within this range of locations, then a positive determination that the concrete mixing vehicle is in the target vehicle location is made.

In some embodiments, the vehicle positioning sensors additionally determine an orientation of the concrete delivery vehicle, and the method further comprises determining that the concrete mixing vehicle is in a correct orientation at the target location.

During positioning of the concrete mixing vehicle, a relative position of the concrete mixer vehicle to the target delivery location may be determined using the one or more chute positioning sensors and/or the one or more vehicle positioning sensors. This relative position may be displayed to an operator of the vehicle via a display in the cab of the vehicle. The display may indicate the current position of the vehicle, the position of the target delivery location and, optionally, a range from the vehicle to the target delivery location. In some embodiments, the area reachable by the delivery chute at the current vehicle position may also be displayed.

In response to determining that the vehicle is at the target location, the method proceeds to operation 4.2; otherwise, operation 4.1 is repeated.

At operation 4.2, deployment of the delivery chute from the concrete mixing vehicle is initiated. The deployment may be initiated manually by the operator from the cab in response to an indication that the concrete mixer vehicle is at the target location.

At operation 4.3, the delivery chute is positioned to a delivery location using one or more actuators of the delivery chute, and based on data from the one or more chute positioning sensors. The positioning may be a fully automated process, or have at least some degree of manual control.

The one or more actuators for positioning the delivery chute may comprise one or more of: an electric motor; a hydraulic motor; and/or lead screws. The one or more chute positioning sensors may comprise any one or more of: one or more optical sensors; one or more LIDAR sensors; one or more acoustic sensors; one or more displacement sensors; and/or motor encoders.

The actuators may extend the chute, raise and/or lower the chute and/or rotate the chute in the around a vertical axis. The actuators may automatically position the delivery chute at a pre-defined height above the target delivery location.

During positioning of the delivery chute, data from the one or more chute positioning sensors to determine whether an obstacle is present in the path of the delivery chute (i.e. the path from the vehicle to the target delivery location). If an obstacle is detected, the delivery chute path may be adjusted to avoid the detected object. Alternatively, motion of the delivery chute may be halted until the object is no longer detected.

At operation 4.4, once the delivery chute is positioned at the delivery location, an indication that the chute is in a correct position for concrete delivery is output to the user of the vehicle. For example, a visual indication may be provided via a display in the cab of the vehicle. Alternatively or additionally, an audio indication may be provided via an audio system in the cab of the vehicle.

In some embodiments, the method may further comprise delivering the concrete mix from the concrete mixing vehicle to the delivery location. For example, subsequent to indicating that the chute is in a correct position for concrete delivery, a user may initiate the delivery from the cab of the vehicle. During delivery of the concrete mix, vertical and/or horizontal oscillations may be applied to the delivery chute by the actuators.

Following delivery of the concrete mix, the chute may be positioned in a wash-down position (e.g. above a wash-box and/or away from the target delivery location). Water may be expelled from one or more outlets of the delivery chute when in the wash-down position in order to clean the delivery chute.

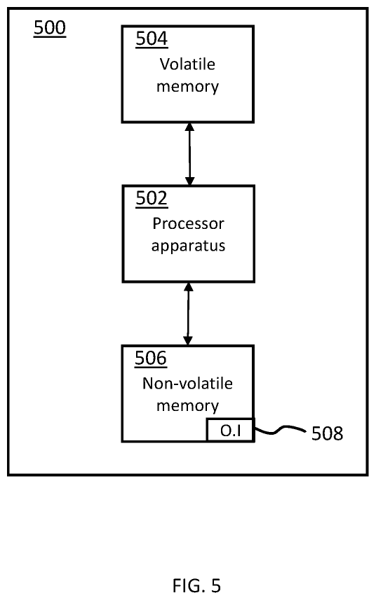

FIG. 5 shows a schematic overview of a computer system for use in performing any of the methods described herein. The system/apparatus 500 may form at least a part of a concrete mixer, e.g. part of an ECU of a concrete mixer.

The apparatus (or system) 500 comprises one or more processors 502. The one or more processors control operation of other components of the system/apparatus 500. The one or more processors 502 may, for example, comprise a general-purpose processor. The one or more processors 502 may be a single core device or a multiple core device. The one or more processors 502 may comprise a Central Processing Unit (CPU) or a graphical processing unit (GPU). Alternatively, the one or more processors 802 may comprise specialised processing hardware, for instance a RISC processor or programmable hardware with embedded firmware. Multiple processors may be included.

The system/apparatus comprises a working or volatile memory 504. The one or more processors may access the volatile memory 504 in order to process data and may control the storage of data in memory. The volatile memory 504 may comprise RAM of any type, for example, Static RAM (SRAM) or Dynamic RAM (DRAM), or it may comprise Flash memory, such as an SD-Card.

The system/apparatus comprises a non-volatile memory 506. The non-volatile memory 506 stores a set of operation instructions 508 for controlling the operation of the processors 502 in the form of computer readable instructions. The non-volatile memory 506 may be a memory of any kind such as a Read Only Memory (ROM), a Flash memory or a magnetic drive memory.

The one or more processors 502 are configured to execute operating instructions 508 to cause the system/apparatus to perform any of the methods described herein. The operating instructions 508 may comprise code (i.e. drivers) relating to the hardware components of the system/apparatus 500, as well as code relating to the basic operation of the system/apparatus 500. Generally speaking, the one or more processors 502 execute one or more instructions of the operating instructions 508, which are stored permanently or semi-permanently in the non-volatile memory 506, using the volatile memory 504 to store temporarily data generated during execution of said operating instructions 508.

Any mentioned apparatus and/or other features of particular mentioned apparatus may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc.), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description, it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures.

1. A system for positioning a delivery chute of a concrete mixer vehicle, the system comprising:
one or more vehicle positioning sensors for determining location data specifying a location of the concrete mixer vehicle;
the delivery chute for delivering the concrete mix from a concrete mixing drum to a target location, the delivery chute comprising:
one or more chute positioning sensors for monitoring a position of the delivery chute; and
one or more actuators for positioning the delivery chute;
one or more processors; and
a memory, the memory storing computer readable instructions that, when executed by the one or more processors, cause the system to perform a method comprising:
determining, based on the location data, whether the concrete mixer vehicle is at a target vehicle location;
initiating, based at least in part on determining that the concrete mixer vehicle is at the target vehicle location, deployment of the delivery chute from the concrete mixing vehicle;
positioning, based at least in part on data from the one or more chute positioning sensors, the delivery chute to a target delivery location using the one or more actuators; and
indicating, to a user of the concrete mixer vehicle, that the chute is in a correct position for concrete delivery at the target delivery location.

2. The system of claim 1, wherein the method further comprises determining the target vehicle position based on based on the target delivery location and a set of positions reachable by the delivery chute from the concrete mixer vehicle.

3. The system of any of claims 1 or 2, wherein the one or more vehicle positioning sensors comprises an optical sensor, and wherein determining whether the concrete mixer vehicle is at the target vehicle location comprises detecting an optical marker using the optical sensor.

4. The system of any preceding claim, wherein the one or more vehicle positioning sensors comprises an satellite positioning sensor, and wherein determining whether the concrete mixer vehicle is at the target vehicle location comprises detecting that the vehicle is in a predefined location or range of locations using the satellite positioning sensor.

5. The system of any preceding claim, wherein the one or more vehicle positioning sensors comprises a laser target detection sensor, and wherein determining whether the concrete mixer vehicle is at the target vehicle location comprises detecting a laser marker positioned at the delivery location.

6. The system of any preceding claim, further comprising a display, wherein the method further comprises:
determining, based at least in part on data from the one or more chute positioning sensors and/or the one or more vehicle positioning sensors a position of the concrete mixer vehicle relative to the target delivery location; and
causing the position of the concrete mixer vehicle relative to the target delivery location to be displayed on the display.

7. The system of claim 6, wherein the method further comprises indicating a range of the delivery chute on the display when displaying the position of the concrete mixer vehicle relative to the target delivery location.

8. The system of any preceding claim, wherein positioning the delivery chute to the target delivery location using the one or more actuators comprises automatically positioning the delivery chute at a pre-defined height above the target delivery location.

9. The system of any preceding claim, wherein positioning the delivery chute to a target delivery location using the one or more actuators comprises:
determining, based on data from the one or more chute positioning sensors, presence of an object in the delivery chute path to the target delivery location; and
in response to determining the presence of an object in the delivery chute path to the target delivery location, adjusting the delivery chute path to avoid the detected object or halting motion of the delivery chute until the object is no longer detected.

10. The system of any preceding claim, further comprising, subsequent to indicating that the chute is in a correct position for concrete delivery, delivering the concrete mix from the concrete mixing vehicle to the target delivery location.

11. The system of claim 10, wherein delivering the concrete mix from the concrete mixing vehicle to the delivery location comprises:
determining a slump of the concrete mix; and
setting, based on a target delivery rate and the slump of the concrete mix, a concrete drum rotation speed for delivery of the concrete mix.

12. The system of any of claim 10 or 11, wherein delivering the concrete mix from the concrete mixing vehicle to the delivery location comprises applying, using the one or more actuators, vertical and/or horizontal oscillations to the delivery chute during delivery of the concrete mix.

13. The system of any of claims 10 to 12, wherein the delivery chute further comprises one or more water outlets, and wherein the method further comprises, subsequent to delivering the concrete mix from the concrete mixing vehicle to the delivery location:
positioning, based at least in part on data from the one or more chute positioning sensors, the delivery chute in a wash-down position; and
expelling, from the one or more water outlets, water into the delivery chute.

14. The system of any preceding claim, wherein the one or more actuators for positioning the delivery chute comprises one or more of: an electric motor; a hydraulic motor; and/or lead screws.

15. The system of any preceding claim, wherein the one or more chute positioning sensors comprises any one or more of: one or more optical sensors; one or more LIDAR sensors; one or more acoustic sensors; one or more displacement sensors; and/or motor encoders.

16. A concrete mixer vehicle comprising:
a concrete mixing drum; and
the system of any preceding claim.

17. A computer program product comprising computer readable instructions that, when executed by the system of claim 1, cause the system to perform the method of any of claims 1-15.
